(19) United States
(12) Patent Application Publication
(10) Pub. No.: US 2024/0342611 A1
(43) Pub. Date: Oct. 17, 2024

(54) GAME OPERATION GUIDING METHOD AND APPARATUS, AND ELECTRONIC DEVICE AND STORAGE MEDIUM

(71) Applicant: NETEASE (HANGZHOU) NETWORK CO., LTD., Hangzhou, Zhejiang (CN)

(72) Inventors: Yukui LIU, Hangzhou, Zhejiang (CN); Jue LONG, Hangzhou, Zhejiang (CN); Le SHANG, Hangzhou, Zhejiang (CN)

(73) Assignee: NETEASE (HANGZHOU) NETWORK CO., LTD., Hangzhou, Zhejiang (CN)

(21) Appl. No.: 18/292,357

(22) PCT Filed: Mar. 16, 2022
(86) PCT No.: PCT/CN2022/081087

§ 371 Date: Jan. 26, 2024

(30) Foreign Application Priority Data
Aug. 17, 2021 (CN) 202110943985.1

(51) Int. Cl. A63F 13/67

(52) U.S. Cl. CPC A63F 13/67

(57) ABSTRACT

A game operation guiding method includes obtaining and running a game protocol corresponding to the game matchup; providing in the game matchup, in response to the game protocol being a non-guiding protocol, a matchup performance corresponding to the non-guiding protocol; and providing in the game matchup, in response to the game protocol being a guiding protocol, operation guiding information corresponding to the guiding protocol, thereby guiding a player of the client to complete a designated game operation.

### CROSS-REFERENCE TO RELATED APPLICATIONS

The present disclosure is the U.S. national phase application of PCT Application No. PCT/CN2022/081087, filed on Mar. 16, 2022, which claims the priority to the Chinese Patent Application No. 202110943985.1, entitled “GAME OPERATION GUIDING METHOD AND APPARATUS, AND ELECTRONIC DEVICE AND STORAGE MEDIUM”, filed on Aug. 17, 2021, and the entire contents of both of which are incorporated herein by reference for all purposes.

### TECHNICAL FIELD

The present disclosure relates to the field of game technology, and in particular to a game operation guiding method and apparatus, an electronic device and a storage medium.

### BACKGROUND

With the continuous development of Internet technology, terminal devices such as smart phones, personal computers, and tablets are widely used, and online games are gradually entering people's lives, making games one of the increasingly important entertainment activities.

In the game, novice guidance is the first session that players encounter after entering the game. The importance of the novice guidance is self-evident. Good novice guidance can allow players to quickly familiarize themselves with the game operations and game contents of the game matchup, which is of great help to increase player retention rate.

However, traditional novice guidance solutions rely on the server to guide players of the client to complete designated game operations, such as guiding the player to control the game character to move to a fixed position, or control the game character to launch attacks, etc. Since the novice guidance needs to be completed by the server through guiding the player, there is a problem of server pressure.

### SUMMARY

The present disclosure provides a game operation guiding method that is applied to a client. The method includes: entering a game matchup, obtaining and running a game protocol corresponding to the game matchup: when the game protocol is a non-guiding protocol, providing in the game matchup a matchup performance corresponding to the non-guiding protocol; and when the game protocol is a guiding protocol, providing in the game matchup operation guiding information corresponding to the guiding protocol, thereby guiding a player of the client to complete a designated game operation.

The present disclosure also provides an electronic device. The electronic device includes a processor, a memory and a computer program stored in the memory and capable of running on the processor. The computer program, when executed by the processor, implements steps of the game operation guiding method described above.

Another aspect of the present disclosure provides a non-transitory computer-readable storage medium. The computer-readable storage medium stores a computer program. The computer program, when executed by a processor, implements steps of the game operation guiding method described above.

### BRIEF DESCRIPTION OF THE DRAWINGS

In order to more clearly illustrate the embodiments of the present disclosure, the following will briefly introduce the accompanying drawings that need to be used in the embodiments. It should be understood that the following accompanying drawings only show certain embodiments of the present disclosure, and therefore should not be regarded as a limitation to the scope, and other accompanying drawings may be obtained from these drawings by those ordinary skilled in the art without creative labor.

FIG. 1 is a flowchart of steps of a game operation guiding method of an embodiment of the present disclosure;

FIG. 2 is a structural block diagram of a game operation guiding apparatus of an embodiment of the present disclosure.

### DETAILED DESCRIPTION

In order to make the above objectives, features and advantages of the present disclosure more obvious and understandable, the present disclosure is described in further detail below in conjunction with the accompanying drawings and the detailed description.

Currently, the following solutions are used for the traditional novice guidance.

Solution 1: a real server enhanced guiding manner. Specifically, solution 1 is to start a game matchup in the novice guidance stage, and guide, through the enhanced guiding manner, the player of the client to operate the game matchup. The enhanced guiding means that the player must complete the game operation guided by the server.

Solution 2: a real server weak guiding manner. Solution 2 is similar to solution 1, except that the enhanced guiding is replaced by the weak guiding. Herein, the weak guiding means that the player does not have to complete the game operation guided by the server.

Solution 3: introducing the game operation and the game content in the game matchup by playing back a video on the client.

Each of the above solutions has its own defects, which are described specifically in the following.

Defects of solution 1 is that it is a real game matchup, and the game matchup logic is run on the server, if there are a large number of players logging in when the service is just opened, each player will start a game matchup of novice guidance on the server side, when there are a large number of players, a large number of game matchups will be stared at the same time, which puts a certain amount of pressure on the performance of the server. Moreover, since the client is the enhanced guiding manner, the player must complete the operation guided by the server, so operation of the player will be restricted, the degree of operation freedom is not high, and the experience is poor.

Defects of solution 2 is that solution 2 replaces the enhanced guiding with weak guiding on the basis of solution 1, although the degree of operation freedom is improved, it is precisely because of the high degree of freedom that the game operation of the player is very flexible and cannot guarantee that the player operates according to the expected process, which can easily lead to unpredictable results and failing to achieve the guiding effect. At the same time, there is also a problem of server pressure.

Defects of solution 3 is that it is a pure video playback on the client, although it reduces the pressure of the server, the player cannot do any operation, and there is no sense of participation.

In order to solve the above technical problems, the embodiments of the present disclosure provide a solution for game matchup guiding, which ensures that the guiding process is controllable, and also allows the player to have a certain operation space and a sense of participation.

Specifically, the game matchup logic of the client is completely based on the server side protocol. For the client, the game matchup performance effect of running the real game matchup protocol is consistent with the game matchup performance effect of running the protocol that is read from the video. The game matchup guiding uses the form of protocol recording, and recording ensures the controllable guiding process compared to the real server side game matchup.

In the process of recording, the server side may start a real game matchup according to the process of guiding, and then configure to set a suspension through planning at the time when the player needs to be guided to operate. At the time of suspension, the client may operate the game matchup according to the way it wants to guide the player to operate (click a certain point on the ground to move, click a certain button to release skills, etc.), and the server may process the operation of the player according to the normal game matchup operation, and all protocol data downlinked to the player during the game matchup is saved.

The game matchup guiding is run in the form of protocol recording, and the client may start a real client game matchup. When the player enters the game and starts the game matchup guiding, there is no need to create a real game matchup on the server, and only the client needs to play the locally recorded game matchup recording, and then execute the protocol in the recording according to an order of the protocol timestamp. At this time, the real client game matchup is running, which is simply driven by the recorded protocol. Therefore, during the play back, the player can perform all pure client operations such as dragging the lens. When the playback reaches the suspension node for guiding, the client only suspends the execution of the protocol. After the operation is performed based on the guiding, the subsequent protocol is continued to be executed until the play back of the recording is completed, and then the whole game matchup guiding is completed.

The game operation guiding method in the embodiments of the present disclosure may be run on a terminal device or a server. The terminal device may be a local terminal device. When the game operation guiding method is run on the server, the game may be a cloud game.

In an optional embodiment, the cloud game refers to the game manner based on cloud computing. In the running mode of the cloud game, the running subject of the game program and the presentation subject of the game footage are separated, and the storage and running of the game operation guiding method are completed on the cloud game server. The cloud game client is used for data reception, data sending and presentation of the game footage. For example, the cloud game client may be a display device with data transmission functions near the user side, such as a mobile terminal, TV, computer, PDA, etc. However, the terminal device for processing the game data is the cloud game server in the cloud. When the game is performed, the player operates the cloud game client to send an operation instruction to the cloud game server: the cloud game server runs the game according to the operation instruction, encodes and compresses data such as the game footage, returns the data to the cloud game client via a network; and finally, the cloud game client decodes the data and outputs the game footage.

In an optional embodiment, the terminal device may be a local terminal device. The local terminal device stores the game program, and is used for presenting the game footage. The local terminal device is used for interacting with the player through the graphical user interface, i.e., routinely downloading and installing the game program via the electronic device and running the game program on the electronic device. The local terminal device may provide the graphical user interface to the player in a variety of ways, for example, the graphical user interface may be rendered on a display screen of the terminal, alternatively, the graphical user interface may be provided to the player by holographic projection. For example, the local terminal device may include a display screen and a processor. The display screen is configured for presenting the graphical user interface. The graphical user interface includes the game footage. The processor is configured for running the game, generating the graphical user interface, and controlling the display of the graphical user interface on the display screen.

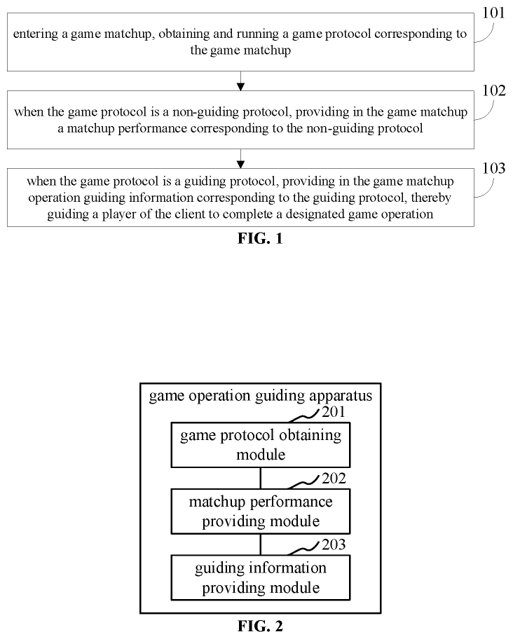

Referring to FIG. 1, a flowchart of steps of a game operation guiding method of an embodiment of the present disclosure is shown. The method is applied to a client. The embodiment of the present disclosure may specifically include the following steps 101 to 103.

At step 101, a game matchup is entered, and a game protocol corresponding to the game matchup is obtained and run.

The game protocol of the game matchup is pre-recorded by the planner according to requirements. Specifically, in the recording process of the game protocol, the server side starts a game matchup, and then the planner configures to set in the game matchup a guiding node at a time when the player needs to be guided to complete a designated game operation. Finally, all of the game protocol within the game matchup may be saved. Subsequently, the playback of the recording of the game matchup may be performed on the client based on the saved game protocol.

Specifically, when the client enters the game matchup, if the game matchup is a game matchup for novice guidance, the game protocol corresponding to the game matchup may be obtained and run.

At step 102, a matchup performance corresponding to the non-guiding protocol is provided in the game matchup when the game protocol is a non-guiding protocol.

The game protocol of the game matchup may include the non-guiding protocol, and the non-guiding protocol is a game protocol used for controlling the matchup performance in the game matchup. For example, the non-guiding protocol may include, but is not limited to, an entry protocol, a movement protocol, a strike-receipt protocol, and an adding/deleting BUFF (gain) protocol.

The entry protocol includes some basic information about the game matchup (map of the matchup, initial information about each game unit, etc.), and is used for initializing the game matchup on the client.

The movement protocol is used for the client to provide a matchup performance of movement.

The strike-receipt protocol is used for the client to provide a matchup performance of strike-receipt.

The adding/deleting BUFF (gain) protocol is used for the client to provide a matchup performance of adding or deleting BUFF for the game character.

At step 103, operation guiding information corresponding to the guiding protocol is provided in the game matchup when the game protocol is a guiding protocol, thereby guiding a player of the client to complete a designated game operation.

The game protocol of the game matchup may include the non-guiding protocol and the guiding protocol. The guiding protocol is used for guiding the client to complete the designated game operation. For example, the guiding protocol may include a movement guiding protocol and a skill release guiding protocol.

The movement guiding protocol includes the ID of the game unit and the target point of the movement of the game unit.

The skill release guiding protocol includes the ID of the game unit and the game skill released by the game unit.

In addition to the above exemplarily proposed game protocols such as the movement protocol and the game skill release protocol, there are other different types of game protocols, and different game protocols have corresponding matchup performances on the client. The game protocols may be agreed upon by the client/server side together, and then the server side needs to notify the game protocol to the client at certain times, enabling the client to do the corresponding matchup performance.

In the embodiments of the present disclosure, the video recording is used as guidance, which can ensure the controllability of the guiding process. After encountering the guiding protocol in the video recording, the client may provide corresponding guiding for the player to move/release skills, and in the player's view; this is a real game matchup with enhanced guiding.

In the game operation guiding method described above, when the game matchup is entered, the game protocol corresponding to the game matchup is obtained and run, if the game protocol is the non-guiding protocol, the matchup performance corresponding to the non-guiding protocol is provided in the game matchup, and if the game protocol is the guiding protocol, the operation guiding information corresponding to the guiding protocol is provided in the game matchup, thereby guiding the player of the client to complete the designated game operation. The embodiments of the present disclosure pre-configure the game protocol of the game matchup according to the guiding requirement, so that the player can be provided with the matchup performance or the operation guiding information according to the game protocol when the game matchup is run on the client. Since server participation is not required, server pressure is not high. Furthermore, no player operation is required when the matchup performance is provided, and the player can be guided to complete the designated game operation when the operation guiding information is provided. In this way, players have a certain amount of operation space and a strong sense of participation, providing them with a higher degree of freedom on the basis of ensuring that they can normally complete the designated game operation.

In an optional embodiment of the present disclosure, the step 101, obtaining and running the game protocol corresponding to the game matchup, may include the following steps: obtaining the game protocol corresponding to the game matchup, where the game protocol is provided with a corresponding timestamp; and running the game protocol according to an order of the timestamp.

Specifically, when the game protocol of the game matchup is recorded, the timestamp corresponding to each game protocol is also saved, and when the game protocol corresponding to the game matchup is obtained, the client regularly checks the timestamp of the game protocol and runs the game protocol according to the order of the timestamp of the game protocol, so as to enable the game matchup to be run normally on the client.

In an optional embodiment of the present disclosure, after running the game protocol according to the order of the timestamp, the method further include the following step: deleting the game protocol after the running of the game protocol is completed.

Specifically, when running the game protocol of the game matchup on the client, the client regularly checks the timestamp of the game protocol and deletes the expired game protocol to avoid causing lagging on the client due to occupying too much memory on the client.

In an optional embodiment of the present disclosure, after providing in the game matchup the operation guiding information corresponding to the guiding protocol, the method further includes the following steps: receiving a protocol suspension instruction; and suspending, based on the protocol suspension instruction, running a subsequent game protocol.

Specifically, when the client is running in accordance with the game protocol, if the client encounters the guiding protocol (guiding the movement of the game character, guiding the release of skills, etc.), the client receives the protocol suspension instruction sent by the server side, at which time the client may suspend the running of the other game protocols following the guiding protocol and wait for the client to complete the guiding.

In the embodiment of the present disclosure, when the client runs into the guiding protocol, corresponding guiding information is provided on the client based on the game operation guiding information of the guiding protocol, the running of the game protocol is suspended to wait for the player to complete the corresponding guiding operation, for example, selecting a game character and moving to a common position point in the game.

In an optional embodiment of the present disclosure, the method may further include the following steps: receiving a suspension release instruction; and continuing to run, based on the suspension release instruction, the subsequent game protocol, where the suspension release instruction is generated after detecting that the player of the client completes the designated game operation.

Specifically, the game operation of the player on the client is acquired in real time and reported to the server, and the server may determine the game operation of the player on the client, if the server determines that the player has completed the designated game operation according to the game operation guiding information, the server may send the suspension release instruction to the client, the client may continue to run, based on the suspension release instruction, the subsequent game protocol following the guiding protocol until the completion of the whole game matchup.

In an optional embodiment of the present disclosure, after the step 102 of obtaining and running the game protocol corresponding to the game matchup, the method may further include the following steps: detecting a client operation on the client; and if the game protocol in running is the non-guiding protocol, allowing execution of the client operation, where the client operation at least includes a lens drag operation.

Specifically, since the game matchup running on the client is a real client battle, and it is simply that the game matchup is driven based on the recorded game protocol, the player can perform all pure client operations such as dragging the lens during the process of the driving of the game matchup based on the recorded game protocol, and this will not have an effect on running the game protocol of the game matchup in order.

In an optional embodiment of the present disclosure, after obtaining and running the game protocol corresponding to the game matchup, the method may further include the following steps: if the game protocol in running is the guiding protocol, prohibiting the execution of the client operation.

Optionally, in order to ensure that the player on the client can complete the designated game operation according to the guiding, in the embodiment of the present disclosure, the guiding process may be set to be an enhanced guiding manner, i.e., the player is prohibited from performing lens dragging and other operations on the client at this time, so as to avoid unpredictable results and failing to achieve the guiding effect.

In order to enable those ordinary skilled in the art to better understand the embodiments of the present disclosure, the following is a complete example for explanation, which is specifically divided into two parts: protocol recording and protocol running of the game protocol.

The protocol recording is divided into the following steps.
1. According to the requirement of the guiding, the planner configures the guiding process of the whole game matchup.
2. The server starts a real game matchup according to the configuration.
3. The normal game matchup logic is executed. When the guiding node (character movement, releasing skills, etc.) is encountered, the server side suspends the game matchup, downlinks the guiding information to the client, and waits for the client to complete the guiding.
4. After receiving the guiding information, the client performs corresponding guiding functions according to different guiding contents, the running of the game protocol is suspended to wait for the player to complete the corresponding guiding operation (e.g. selecting the character to move to a certain point). After completing the guiding operation, the client notifies the server side to release the suspension.
5. The server side receives the end of the guiding and continues to run the subsequent game matchup logic until the end of a game matchup.
6. All of the game protocol of the game matchup is saved, which is used for driving a game matchup on the client based on the recorded game protocol.

The client runs the game protocol, which includes the following steps.
1. Because the logic of the client is completely based on the protocol, reading the recorded protocol is equivalent to simulating the downlinking of the protocol by the server side, and a client game matchup is started based on the contents of the recorded game protocol.
2. The client regularly checks the timestamp of the game protocol, and runs the game protocol and deletes the expired game protocol.
3. When the game protocol related to the guiding is to be executed, the running of the game protocol is suspended, and the player is prompted to complete the corresponding guiding.
4. After the player completes the corresponding guiding, the subsequent game protocol is continued to run until the end of the game matchup.

Beneficial effects brought about by applying the technical solutions of the embodiments of the present disclosure are as follows.
1. There is no need to create a game matchup for each player on the server, reducing the server pressure.
2. The player has a certain operation space and a strong sense of participation, providing the player with a higher degree of freedom on the basis of ensuring the operation is performed according to the guiding process.

It should be illustrated that the method embodiments are all expressed as a series of action combinations for the sake of simple description. However, those skilled in the art should be aware that the embodiments of the present disclosure are not limited by the order of the described actions, as according to the embodiments of the present disclosure, certain steps can be performed in other sequences or simultaneously. Secondly, those skilled in the art should also be aware that the embodiments described in the specification are all preferred embodiments, and the actions involved may not necessarily be necessary for the embodiments of the present disclosure.

Referring to FIG. 2, structural block diagram of a game operation guiding apparatus of an embodiment of the present disclosure is shown. The apparatus is applied to a client. The apparatus may specifically include a game protocol obtaining module 201, a matchup performance providing module 102 and a guiding information providing module 203.

The game protocol obtaining module 102 is configured to enter a game matchup, and obtain and run a game protocol corresponding to the game matchup.

The matchup performance providing module 102 is configured to provide, in the game matchup when the game protocol is a non-guiding protocol, a matchup performance corresponding to the non-guiding protocol.

The guiding information providing module 203 is configured to provide, in the game matchup when the game protocol is a guiding protocol, operation guiding information corresponding to the guiding protocol, thereby guiding a player of the client to complete a designated game operation.

In an optional embodiment of the present disclosure, the game protocol obtaining module 201 is configured to: obtain the game protocol corresponding to the game matchup, where the game protocol is provided with a corresponding timestamp; and run the game protocol according to an order of the timestamp.

In an optional embodiment of the present disclosure, the apparatus further includes a game protocol deleting module that is configured to delete the game protocol after the running of the game protocol is completed.

In an optional embodiment of the present disclosure, the apparatus further includes a suspension module that is configured to: receive a protocol suspension instruction; and suspend, based on the protocol suspension instruction, running a subsequent game protocol.

In an optional embodiment of the present disclosure, the apparatus further includes a suspension release module that is configured to: receive a suspension release instruction; and continue to run, based on the suspension release instruction, the subsequent game protocol, where the suspension release instruction is generated after detecting that the player of the client completes the designated game operation.

In an optional embodiment of the present disclosure, the apparatus further includes a client operation allowing module that is configured to: detect a client operation on the client; and allow execution of the client operation if the game protocol in running is the non-guiding protocol, where the client operation at least includes a lens drag operation.

In an optional embodiment of the present disclosure, the apparatus further includes a client operation prohibiting module that is configured to prohibit the execution of the client operation if the game protocol in running is the guiding protocol.

To sum up, in the embodiments of the present disclosure, when the game matchup is entered, the game protocol corresponding to the game matchup is obtained and run, if the game protocol is the non-guiding protocol, the matchup performance corresponding to the non-guiding protocol is provided in the game matchup, and if the game protocol is the guiding protocol, the operation guiding information corresponding to the guiding protocol is provided in the game matchup, thereby guiding the player of the client to complete the designated game operation. The embodiments of the present disclosure pre-configure the game protocol of the game matchup according to the guiding requirement, so that the player can be provided with the matchup performance or the operation guiding information according to the game protocol when the game matchup is run on the client. Since server participation is not required, server pressure is not high. Furthermore, no player operation is required when the matchup performance is provided, and the player can be guided to complete the designated game operation when the operation guiding information is provided. In this way, players have a certain amount of operation space and a strong sense of participation, providing them with a higher degree of freedom on the basis of ensuring that they can normally complete the designated game operation.

For the apparatus embodiment, due to its basic similarity with the method embodiment, the description is relatively simple. Please refer to part of the description of the method embodiment for relevant information.

An embodiment of the present disclosure provides an electronic device. The electronic device includes a processor, a memory and a computer program stored in the memory and capable of running on the processor. The computer program, when executed by the processor, implements steps of the game operation guiding method embodiment described above.

A game operation guiding method is applied to a client. The method includes: entering a game matchup, obtaining and running a game protocol corresponding to the game matchup: when the game protocol is a non-guiding protocol, providing in the game matchup a matchup performance corresponding to the non-guiding protocol; and when the game protocol is a guiding protocol, providing in the game matchup operation guiding information corresponding to the guiding protocol, thereby guiding a player of the client to complete a designated game operation.

Optionally, the obtaining and running the game protocol corresponding to the game matchup includes: obtaining the game protocol corresponding to the game matchup, where the game protocol is provided with a corresponding timestamp; and running the game protocol according to an order of the timestamp.

Optionally, after the running the game protocol according to the order of the timestamp, the method further includes deleting the game protocol after the running of the game protocol is completed.

Optionally, after the providing in the game matchup the operation guiding information corresponding to the guiding protocol, the method further includes: receiving a protocol suspension instruction; and suspending, based on the protocol suspension instruction, running a subsequent game protocol.

Optionally, after the providing in the game matchup the operation guiding information corresponding to the guiding protocol, the method further includes: receiving a suspension release instruction; and continuing to run, based on the suspension release instruction, the subsequent game protocol, where the suspension release instruction is generated after detecting that the player of the client completes the designated game operation.

Optionally, after the obtaining and running the game protocol corresponding to the game matchup, the method further includes: detecting a client operation on the client; and if the game protocol in running is the non-guiding protocol, allowing execution of the client operation, where the client operation at least includes a lens drag operation.

Optionally, after the obtaining and running the game protocol corresponding to the game matchup, the method further includes: if the game protocol in running is the guiding protocol, prohibiting the execution of the client operation.

The embodiments of the present disclosure include the following advantages.

In the embodiments of the present disclosure, when the game matchup is entered, the game protocol corresponding to the game matchup is obtained and run, if the game protocol is the non-guiding protocol, the matchup performance corresponding to the non-guiding protocol is provided in the game matchup, and if the game protocol is the guiding protocol, the operation guiding information corresponding to the guiding protocol is provided in the game matchup, thereby guiding the player of the client to complete the designated game operation. The embodiments of the present disclosure pre-configure the game protocol of the game matchup according to the guiding requirement, so that the player can be provided with the matchup performance or the operation guiding information according to the game protocol when the game matchup is run on the client. Since server participation is not required, server pressure is not high. Furthermore, no player operation is required when the matchup performance is provided, and the player can be guided to complete the designated game operation when the operation guiding information is provided. In this way, players have a certain amount of operation space and a strong sense of participation, providing them with a higher degree of freedom on the basis of ensuring that they can normally complete the designated game operation.

An embodiment of the present disclosure provides a computer-readable storage medium. The computer-readable storage medium stores a computer program. The computer program, when executed by a processor, implements steps of the game operation guiding method embodiment described above.

A game operation guiding method is applied to a client. The method includes: entering a game matchup, obtaining and running a game protocol corresponding to the game matchup: when the game protocol is a non-guiding protocol, providing in the game matchup a matchup performance corresponding to the non-guiding protocol; and when the game protocol is a guiding protocol, providing in the game matchup operation guiding information corresponding to the guiding protocol, thereby guiding a player of the client to complete a designated game operation.

Optionally, the obtaining and running the game protocol corresponding to the game matchup includes: obtaining the game protocol corresponding to the game matchup, where the game protocol is provided with a corresponding timestamp; and running the game protocol according to an order of the timestamp.

Optionally, after the running the game protocol according to the order of the timestamp, the method further includes deleting the game protocol after the running of the game protocol is completed.

Optionally, after the providing in the game matchup the operation guiding information corresponding to the guiding protocol, the method further includes: receiving a protocol suspension instruction; and suspending, based on the protocol suspension instruction, running a subsequent game protocol.

Optionally, after the providing in the game matchup the operation guiding information corresponding to the guiding protocol, the method further includes: receiving a suspension release instruction; and continuing to run, based on the suspension release instruction, the subsequent game protocol, where the suspension release instruction is generated after detecting that the player of the client completes the designated game operation.

Optionally, after the obtaining and running the game protocol corresponding to the game matchup, the method further includes: detecting a client operation on the client; and if the game protocol in running is the non-guiding protocol, allowing execution of the client operation, where the client operation at least includes a lens drag operation.

Optionally, after the obtaining and running the game protocol corresponding to the game matchup, the method further includes: if the game protocol in running is the guiding protocol, prohibiting the execution of the client operation.

The embodiments of the present disclosure include the following advantages.

In the embodiments of the present disclosure, when the game matchup is entered, the game protocol corresponding to the game matchup is obtained and run, if the game protocol is the non-guiding protocol, the matchup performance corresponding to the non-guiding protocol is provided in the game matchup, and if the game protocol is the guiding protocol, the operation guiding information corresponding to the guiding protocol is provided in the game matchup, thereby guiding the player of the client to complete the designated game operation. The embodiments of the present disclosure pre-configure the game protocol of the game matchup according to the guiding requirement, so that the player can be provided with the matchup performance or the operation guiding information according to the game protocol when the game matchup is run on the client. Since server participation is not required, server pressure is not high. Furthermore, no player operation is required when the matchup performance is provided, and the player can be guided to complete the designated game operation when the operation guiding information is provided. In this way, players have a certain amount of operational space and a strong sense of participation, providing them with a higher degree of freedom on the basis of ensuring that they can normally complete the designated game operation.

Each embodiment in this specification is described in a progressive manner, with each embodiment focusing on differences from other embodiments. The same and similar parts between respective embodiments can be referred to each other.

It should be understood by those skilled in the art that the embodiments of the present disclosure may be provided as methods, devices, or computer program products. Accordingly, the embodiments of the present disclosure may take the form of complete hardware embodiments, complete software embodiments, or embodiments that combine software and hardware aspects. Furthermore, the embodiments of the present disclosure may take the form of a computer program product implemented on one or more computer-usable storage media (including, but not limited to, disk memories, CD-ROMs, optical memories, etc.) that includes computer-usable program code.

The embodiments of the present disclosure are described with reference to flowcharts and/or block diagrams of methods, terminal devices (systems), and computer program products according to the embodiments of the present disclosure. It should be understood that each of the processes and/or blocks in the flowcharts and/or block diagrams, and the combination of processes and/or blocks in the flowcharts and/or block diagrams may be implemented by the computer program instructions. These computer program instructions may be provided to a processor of a general-purpose computer, a special-purpose computer, an embedded processor, or other programmable data processing terminal device to produce a machine such that the instructions executed by the processor of the computer or other programmable data processing terminal device produce a device for implementing the designated functions in one or processes of the flowcharts and/or one or more blocks of the block diagrams.

These computer program instructions may also be stored in a computer-readable memory capable of directing the computer or other programmable data processing terminal device to operate in a particular manner such that the instructions stored in that computer-readable memory produce a manufacturing product including an instruction device that implements the designated functions in one or processes of the flowcharts and/or one or more blocks of the block diagrams.

These computer program instructions may also be loaded onto a computer or other programmable data processing terminal device such that a series of operation steps are performed on the computer or other programmable terminal device to produce computer-implemented processing, such that the instructions performed on the computer or other programmable terminal device provide steps for implementing the designated functions in one or processes of the flowcharts and/or one or more blocks of the block diagrams.

Although preferred embodiments of the embodiments of the present disclosure have been described, those skilled in the art may make additional changes and modifications to these embodiments once the underlying inventive concepts are known. Therefore, the appended claims are intended to be construed to include the preferred embodiments as well as all changes and modifications that fall within the scope of the embodiments of the present disclosure.

Finally, it should also be illustrated that in this document, relational terms such as “first” and “second” are used only to distinguish one entity or operation from another, and do not necessarily require or imply any such actual relationship or order between these entities or operations. Further, the terms “include”, “comprise” or any other variant thereof are intended to cover non-exclusive inclusion such that a process, method, object, or terminal device including a set of elements includes not only those elements, but also other elements not explicitly listed, or also elements that are inherent to such process, method, object or terminal device. Without further limitation, the elements limited by the statement “including one . . . ” do not exclude the existence of other identical elements in the process, method, object, or terminal device that includes the elements.

The above provides a detailed introduction to a game operation guiding method and apparatus, an electronic device and a storage medium provided in the present disclosure. Specific examples are applied in this document to explain the principles and implementation methods of the present disclosure. The above illustrations of the embodiments are only used to assist in the understanding of the method of the present disclosure and the core ideas thereof. Meanwhile, for those ordinary skilled in this field, there may be changes in specific implementation methods and application scope based on the ideas of the present disclosure. In summary, the contents of this specification should not be understood as a limitation of the present disclosure.

1. A game operation guiding method, comprising:
entering, by a client device, a game matchup, and obtaining and running, by the client device, a game protocol corresponding to the game matchup;
providing in the game matchup, by the client device in response to the game protocol being a non-guiding protocol, a matchup performance corresponding to the non-guiding protocol; and
providing in the game matchup, by the client device in response to the game protocol being a guiding protocol, operation guiding information corresponding to the guiding protocol, thereby guiding a player of the client to complete a designated game operation.

2. The method according to claim 1, wherein
the game protocol is provided with a corresponding timestamp; and
wherein running the game protocol comprises: running the game protocol according to an order of the timestamp.

3. The method according to claim 1, further comprising:
deleting the game protocol in response to the running of the game protocol being completed.

4. The method according to claim 1, further comprising:
receiving a protocol suspension instruction; and
suspending, based on the protocol suspension instruction, running the guiding protocol.

5. The method according to claim 4, further comprising:
receiving a suspension release instruction; and
continuing to run, based on the suspension release instruction, the guiding protocol, wherein the suspension release instruction is generated in response to detecting that the player of the client completes the designated game operation.

6. The method according to claim 1, further comprising:
detecting a client operation on the client; and
allowing, in response to the game protocol in running being the non-guiding protocol, execution of the client operation, wherein the client operation at least comprises a lens drag operation.

7. The method according to claim 1, further comprising:
detecting a client operation on the client; and
prohibiting, in response to the game protocol in running being the guiding protocol, execution of the client operation.

8. (canceled)

9. An electronic device, comprising a processor, a memory and a computer program stored in the memory and capable of running on the processor, wherein the processor, through executing the computer program, is configured to:
enter a game matchup, and obtain and run a game protocol corresponding to the game matchup;
provide, in the game matchup in response to the game protocol being a non-guiding protocol, a matchup performance corresponding to the non-guiding protocol; and
provide, in the game matchup in response to the game protocol being a guiding protocol, operation guiding information corresponding to the guiding protocol, thereby guiding a player of the client to complete a designated game operation.

10. A non-transitory computer-readable storage medium, wherein the computer-readable storage medium stores a computer program, and the computer program, when executed by a processor, implements a game operation guiding method, wherein the game operation guiding method comprises:
entering a game matchup, and obtaining and running a game protocol corresponding to the game matchup;
providing, in the game matchup in response to the game protocol being a non-guiding protocol, a matchup performance corresponding to the non-guiding protocol; and
providing, in the game matchup in response to the game protocol being a guiding protocol, operation guiding information corresponding to the guiding protocol, thereby guiding a player of the client to complete a designated game operation.

11. The electronic device according to claim 9, wherein the game protocol is provided with a corresponding timestamp, and the processor is specifically configured to:
run the game protocol according to an order of the timestamp.

12. The electronic device according to claim 9, wherein the processor is further configured to:
delete the game protocol in response to the running of the game protocol being completed.

13. The electronic device according to claim 9, wherein the processor is further configured to:
receive a protocol suspension instruction; and
suspend, based on the protocol suspension instruction, running the guiding protocol.

14. The electronic device according to claim 13, wherein the processor is further configured to:
receive a suspension release instruction; and
continue to run, based on the suspension release instruction, the guiding protocol, wherein the suspension release instruction is generated in response to detecting that the player of the client completes the designated game operation.

15. The electronic device according to claim 9, wherein the processor is further configured to:
detect a client operation on the client; and
allow, in response to the game protocol in running being the non-guiding protocol, execution of the client operation, wherein the client operation at least comprises a lens drag operation.

16. The electronic device according to claim 9, wherein the processor is further configured to:
detect a client operation on the client; and
prohibit, in response to the game protocol in running being the guiding protocol, execution of the client operation.

17. The non-transitory computer-readable storage medium according to claim 10, wherein the game protocol is provided with a corresponding timestamp; and
the running the game protocol comprises: running the game protocol according to an order of the timestamp.

18. The non-transitory computer-readable storage medium according to claim 10, wherein the method further comprises:
deleting the game protocol in response to the running of the game protocol being completed.

19. The non-transitory computer-readable storage medium according to claim 10, wherein the method further comprises:
receiving a protocol suspension instruction; and
suspending, based on the protocol suspension instruction, running the guiding protocol.

20. The non-transitory computer-readable storage medium according to claim 19, wherein the method further comprises:
receiving a suspension release instruction; and
continuing to run, based on the suspension release instruction, the guiding protocol, wherein the suspension release instruction is generated in response to detecting that the player of the client completes the designated game operation.

21. The non-transitory computer-readable storage medium according to claim 10, wherein the method further comprises:
detecting a client operation on the client; and
allowing, in response to the game protocol in running being the non-guiding protocol, execution of the client operation, wherein the client operation at least comprises a lens drag operation.
